(19) United States
(12) Patent Application Publication
(10) Pub. No.: US 2022/0111934 A1
(43) Pub. Date: Apr. 14, 2022

(54) Surfboard

(71) Applicant: Guangzhou Fun Factory Inflatables Co. Ltd., Orlando, FL (US)

(72) Inventor: Zhijian Zhou, Chongqing (CN)

(21) Appl. No.: 17/471,741

(22) Filed: Sep. 10, 2021

(30) Foreign Application Priority Data
Sep. 11, 2020 (CN) 202021996363.2

(51) Int. Cl. B63B 32/51; B63B 5/24; B32B 5/02; B32B 3/30; B32B 25/10; B32B 27/12; B32B 27/30; B32B 5/26

(52) U.S. Cl. CPC B63B 32/51; B63B 5/24; B32B 5/024; B32B 3/30; B32B 2270/00; B32B 27/12; B32B 27/304; B32B 5/262; B32B 2307/744; B32B 25/10

(57) ABSTRACT

A surfboard having a body including a top panel and a slip-resistant pad affixed to or integrated into the top panel construction. The slip-resistant pad or top panel includes a textured rubber-plastic layer covering a woven mesh layer. The exterior surface of the slip-resistant mat or top panel is textured, rough and uneven.

This United States utility patent application claims the benefit under 35 U.S.C. 119 of a utility patent application of China, CN Serial No. 202021996363.2, filed on Sep. 11, 2020, and is hereby incorporated by reference.

This invention relates to water sports equipment, in particular to a surfboard.

### BACKGROUND OF THE INVENTION

Existing surfboards usually have a non-slip structure on the panel to prevent the feet from slipping. The non-slip structure is usually EVA foamed cotton glued on the panel. Simple EVA foam cotton is easy to deform, damage, and has a short service life. Furthermore, the above-mentioned EVA foamed cotton needs to be glued and installed on the panel, which is troublesome for assembly.

### SUMMARY OF INVENTION

The present invention aims to solve at least one of the technical problems existing in the prior art and provides a surfboard that including a durable slip-resistant mat affixed to or integrated into the exterior surface of the top panel of the surfboard's body. The surfboard utilizes an improved drop stitch monocoque construction including top and bottom panels interconnected by a filament core, and a perimeter sidewall or skirt joined to the top and bottom panels to form an air tight interior.

In one embodiment of the surfboard of this invention, the surfboard body includes a slip-resistant mat affixed to the top panel. The slip-resistant mat includes a woven mesh fabric layer and an external rubber-plastic layer covering the fabric. The surface of the rubber-plastic layer of the mesh layer has a textured, uneven and rough surface. In a second embodiment, the surfboard body includes a textured exterior layer integrated into the construction of the top body panel. The top panel has at least a woven mesh fabric layer and an exterior rubber-plastic, such as polyvinyl chloride (PVC), layer covering the woven mesh layer. The rubber-plastic layer has a textured, uneven and rough surface. In certain variation of each embodiment, the slip resistant mat or top body panel may include a bottom layer, the bottom layer is made of rubber-plastic material, and the woven mesh layer is disposed between the exterior rubber-plastic layer and the bottom layer.

The teachings of the present invention provide several benefits. By covering the rubber-plastic layer provides slip resistance through the textured exterior structure. The woven mesh layer supports the textured rubber-plastic layer and prevents the slip resistant mat from deforming and tearing, which reduces the probability of damage and improves the service life of the surfboard. The arranging and forming the rubber-plastic layer directly as an integrated structure eliminates the need for subsequent assembly and reducing assembly costs. In addition, with the integrated design of the above-mentioned panel and non-slip structure, compared to the design of laminating EVA foamed cotton on the panel, reduces the problems associated with EVA foamed cotton covering the pattern and makes it easier to fully display the printed pattern on the panel.

The additional aspects and advantages of the present invention will be partly given in the following description, and part of them will become obvious from the following description, or be understood through the practice of the present invention.

### BRIEF DESCRIPTION OF THE DRAWINGS

The above and/or additional aspects and advantages of the present invention will become obvious and easy to understand from the description of the embodiments in conjunction with the following drawings, in which:

FIG. 1 is a schematic structural diagram of a surfboard according to an embodiment of the present invention;

FIG. 2 is an exploded schematic diagram of the surfboard shown in FIG. 1;

FIG. 3 is a schematic diagram of the microstructure of the slip resistant mat shown in FIG. 1;

FIG. 4 is a schematic diagram of another microstructure of the slip resistant mat shown in FIG. 1;

FIG. 5 is a schematic structural diagram of another surfboard according to an embodiment of the present invention;

FIG. 6 is an exploded schematic diagram of the surfboard shown in FIG. 5; and

FIG. 7 is a micro-structure diagram of the surfboard shown in FIG. 5.

### REFERENCE NUMERALS

Surfboard 100

Top Panel 110

Body Interior 111

Sidewall or Skirt 120

Bottom Panel 130

Filament Core 140

Slip-Resistance Mat 200

Woven Mesh Layer 901

Textured Layer 902

Bottom Layer 903

### DESCRIPTION OF THE PREFERRED EMBODIMENT

The embodiments of the present invention will be described in detail below. Examples of the embodiments are shown in the accompanying drawings, wherein the same or similar reference numerals indicate the same or similar elements or elements with the same or similar functions. The embodiments described below with reference to the accompanying drawings are exemplary, and are only used to explain the present utility model, and cannot be understood as a limitation to the present utility model.

In the description of the present invention, it should be understood that the orientation description involved, for example, the orientation or positional relationship indicated by up, down, front, back, left, and right is based on the orientation or positional relationship shown in the drawings, only It is for the convenience of describing and simplifying the description of the present invention, rather than indicating or implying that the device or element referred to must have a specific orientation, be constructed and operated in a specific orientation, and therefore cannot be understood as a limitation of the present invention.

In the description of the present invention, several meanings are one or more, multiple meanings are two or more, greater than, less than, exceeding, etc. are understood to not include the number, and above, below, and within are understood to include the number. If it is described that the first and second are only for the purpose of distinguishing technical features, and cannot be understood as indicating or implying relative importance or implicitly specifying the number of the indicated technical features or implicitly specifying the order of the indicated technical features relationship.

In the description of the present utility model, unless otherwise clearly defined, terms such as setting, installation, and connection should be understood in a broad sense. Those skilled in the art can reasonably determine the specific meaning of the above terms in the utility model based on the specific content of the technical solution.

Referring now to the drawings, illustrate two exemplary embodiments of the surfboard of this invention, which are designated generally as reference numeral 100. In each embodiment, surfboard 100 utilizes an improved drop stitch monocoque construction including a “top” panel 110, a perimeter sidewall or skirt 120, a bottom panel 130 and a filament core 140. Skirt 120 joins to top panel 110 and bottom panel 130 to form an air tight interior 111. Skirt 120 is joined to top panel 110 and bottom panel 130 using a conventional thermal bonding method, such as “hot melt” which is well known in the art. Top panel 110 and bottom panel 130 each have a woven polyester mesh layer 901. Filament core 140 consists of tens of thousands of high tensile polyester threads interwoven and connected between the woven mesh layers 901 of top panel 110 and bottom panel 130 in a conventional drop stitch construction. The drop stitch fabric construction allows surfboard 100 to be inflated to high pressures (up to 30 psi) and maintain its flat rigid shape without bulging the exterior surfaces of top panel 100 and bottom panel 130 when surfboard 100 is properly inflated.

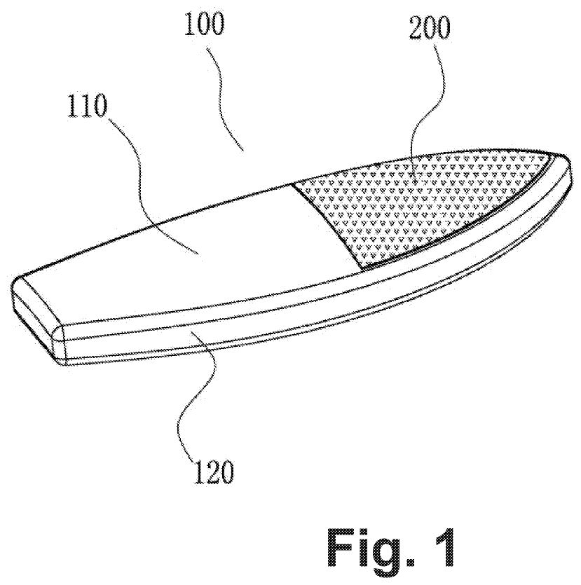

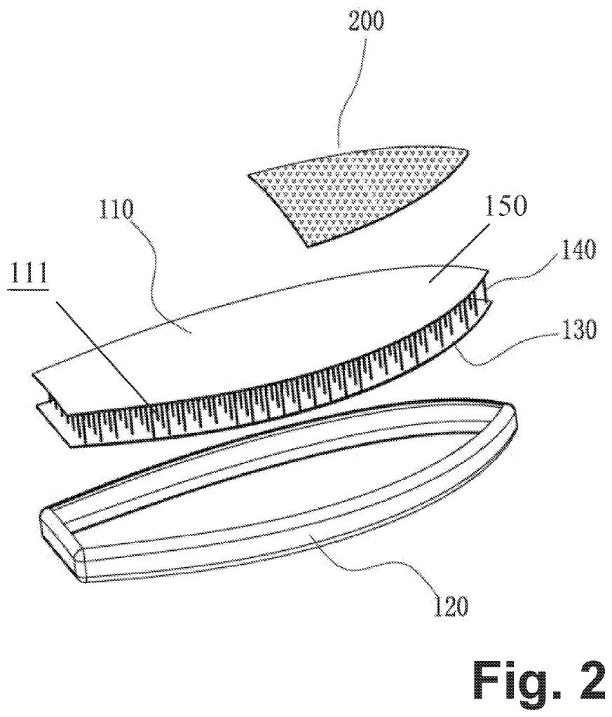

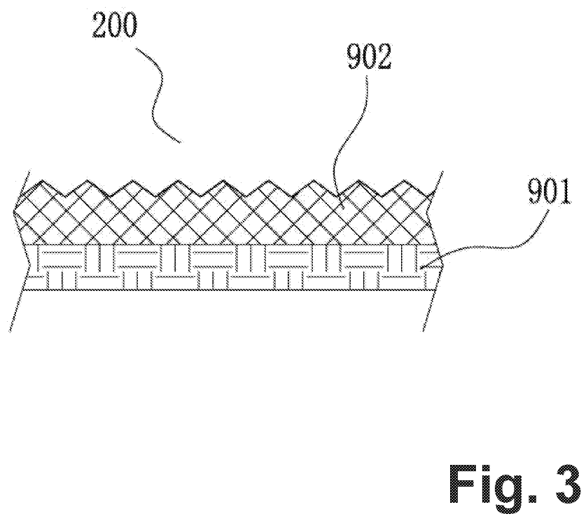

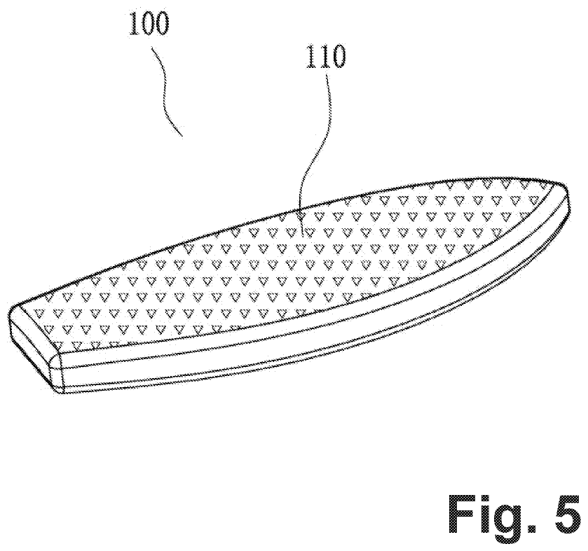

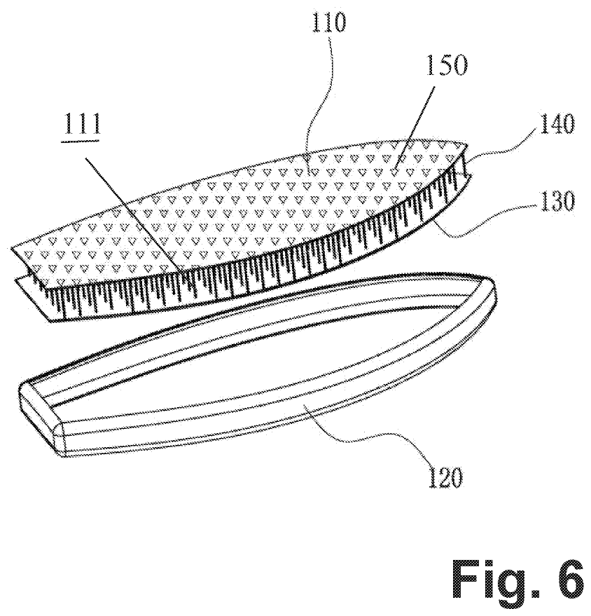

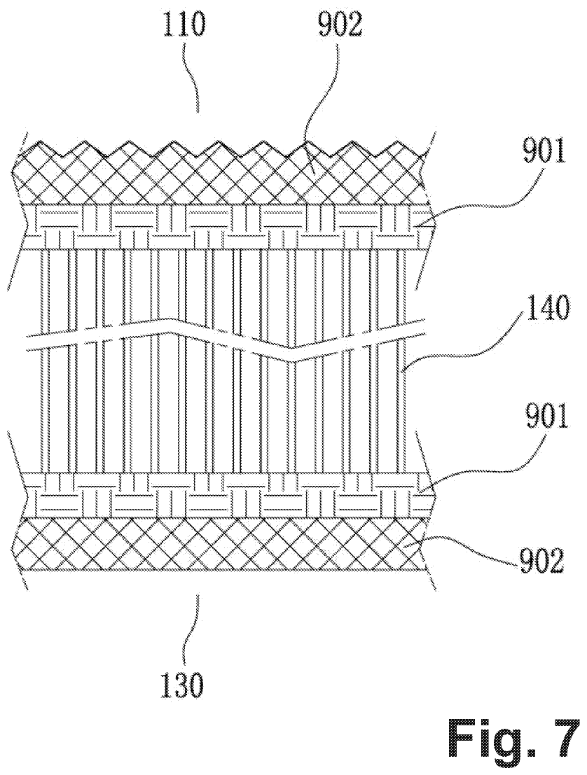

In each embodiment, surfboard 100 also includes a slip-resistant mat 200. In one embodiment (FIGS. 1-4), slip-resistant mat 200 covers a portion of top panel 110 and is glued to the panel 110. In the second embodiment (FIGS. 5-7), slip-resistant mat 200 is integrated into and covers the entire top surface of panel 110. In other embodiments, the anti-skid pad 200 can also be attached to the panel 110 by means of snap connection, fastener connection, magic stick connection, etc.

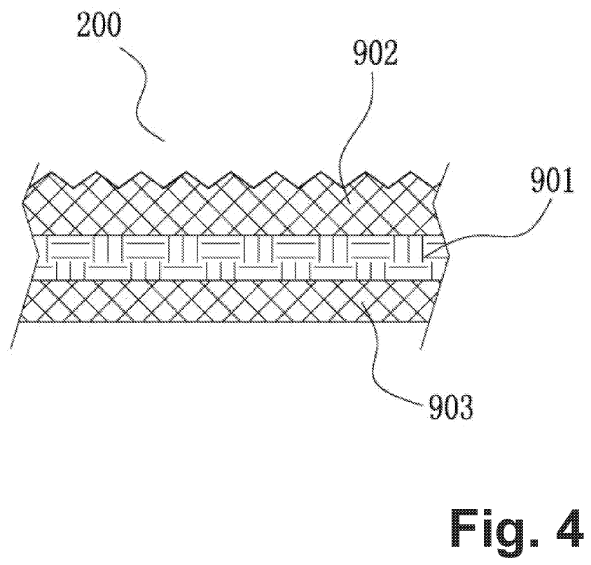

In each embodiment, whether as slip-resistant mat 200 or an integrated structure, a textured exterior layer 902 is bonded to or integrated into woven mesh layer 901 of panel 110. As shown in FIG. 4, slip-resistant mat 200 is formed with woven mesh layer 901 interposed between textured exterior layer 902 and a bottom layer 903. In each embodiment, textured layer 902 is directly bonded to or integrated with woven mesh layer 901 of top panel 110 to form an integrated structure, thereby eliminating the need for subsequent assembly and reducing assembly costs. Textured exterior 902 is made of a rubber material. The exterior surface of “top” rubber-plastic layer 902 of slip-resistant mat 200 has an uneven rough structure, which improves slip resistance. Woven mesh layer 901 of slip resistant mat 200 provides a support structure for rubber-plastic layer 902 and prevents the slip-resistant mat 200 from being easily deformed and torn. Bottom layer 903 is made of rubber and plastic material. Woven mesh layer 901 is disposed between the rubber layer 902 and the bottom layer 903.

Rubber layer 902 may be a PVC layer. In other embodiments, the rubber-plastic layer 902 can also be made of other rubber-plastic materials, such as rubber, PE, resin and so on. Bottom layer 903 is a PVC layer. In other embodiments, the rubber-plastic layer 902 and the bottom layer 903 can also be made of other rubber-plastic materials, such as rubber, PE, resin and so on. By setting the bottom layer 903, the bottom layer 903 and the rubber layer 902 are located on the upper and lower sides of the woven mesh layer 901, which protects the woven mesh layer 901 better. At the same time, the provided bottom layer 903 can also facilitate the non-slip mat 200 to be attached by adhesive.

In the foregoing embodiments of the surfboard, the uneven rough structure can be formed by arranging protruding particles on the surface of the rubber layer 902, and the protruding particles are arranged to form an uneven surface. The shape of the protruding particles can be conical, hemispherical, and so on. Of course, the concave-convex rough structure can also be formed by arranging anti-slip protruding strips and anti-slip grooves on the surface of the rubber-plastic layer 902.

In the above embodiments of the surfboard, molten rubber and plastic can be sprayed on the woven mesh layer 901, and then rolled on the surface of the rubber and plastic through a roller with a rough structure with unevenness to form the above-mentioned uneven rough exterior surface of rubber layer 902. Mesh layer 901 can be woven with textile fibers.

The technical features of the above embodiments can be combined arbitrarily. In order to make the description concise, all possible combinations of the technical features in the above embodiments are not described. However, as long as there is no contradiction in the combination of these technical features, they should be considered as the range described in this specification.

The embodiments of the present utility model are described in detail above in conjunction with the accompanying drawings, but the present utility model is not limited to the above-mentioned embodiments, and within the scope of knowledge possessed by those of ordinary skill in the technical field, it can also be provided without departing from the purpose of the utility model.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An inflatable surfboard (100) comprising:
a first panel (110); and
a slip-resistant mat (200) affixed to the first panel (110),
the slip-resistant mat (200) includes at least a woven mesh layer (901) and a first layer (902) covering the woven mesh layer (901), the first layer (902) has a textured exterior surface.

2. The surfboard of claim 1 wherein the first layer is composed of a rubber and plastic material.

3. The surfboard of claim 1, wherein the slip-resistant mat (200) includes a second layer (903), the mesh layer (901) is interposed between the first layer (902) and the second layer (903).

4. The surfboard of claim 3 wherein the second layer is composed of a rubber and plastic material.

5. The surfboard of claim 1, wherein the first layer (902) is a PVC layer.

6. The surfboard of claim 2, wherein the second layer (903) is a PVC layer.

7. The surfboard of claim 1, and a second panel (130) and a perimeter skirt (120) connecting the first panel (110) and the second panel to form an enclosed interior (111).

6. The surfboard of claim 5 wherein the skirt (120) is thermally bonded to the first panel (110) and the second plate (130).

7. An inflatable surfboard (100) comprising:
a first panel (110), the second panel (110), a filament core interconnected between the first panel (110) and the second panel (130), and perimeter skirt connecting the first panel and the second panel to form an enclosed interior (111),
the first panel has a woven mesh layer (901) and a first layer (902) covering the woven mesh layer (901), the first layer (902) has an uneven slip-resistant exterior surface.

8. The surfboard of claim 7 wherein the first layer (902) is composed of a rubber and plastic material, and the exterior surface is textured.

9. The surfboard of claim 1, wherein the first panel further has a second layer (903), the woven mesh layer (901) is interposed between the first layer (902) and the second layer (903).

10. The surfboard of claim 9 wherein the second layer (903) is composed of a rubber and plastic material.

11. The surfboard of claim 7, wherein the first layer (902) and the second layer (903) are PVC layers.
